(19) United States
(12) Patent Application Publication
(10) Pub. No.: US 2023/0279896 A1
(43) Pub. Date: Sep. 7, 2023

(54) BrowHook

(71) Applicant: Jasveer Singh Sandhu, Findlay, OH (US)

(72) Inventor: Jasveer Singh Sandhu, Findlay, OH (US)

(21) Appl. No.: 18/115,097

(22) Filed: Feb. 28, 2023

Related U.S. Application Data
(60) Provisional application No. 63/268,947, filed on Mar. 7, 2022.

(51) Int. Cl. F16B 45/00

(52) U.S. Cl. CPC F16B 45/00

(57) ABSTRACT

A BrowHook may comprise of a hook that is sufficiently sized, attached to an open securement clip with a retention lip, and having serrations or knurling on contact surfaces to provide additional support and stability when the device is attached to a structure. A BrowHook can be deployed and retired from use on various forms of webbing and rope.

### CROSS-REFERENCE TO RELATED APPLICATIONS

Claiming benefit of previously submitted pending provisional utility patent application 63/268,947 with 371(c) filing date of Mar. 7, 2022.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

### Field

The present disclosure relates generally to hooked devices, in particular, a BrowHook consisting of a hook with a clip having serrations or knurling on its surface(s) to improve traction and stability between the device and the surface it is held to when used against a tree or other structure in tandem with a piece of webbing or rope which it can be quickly removed from or shifted along.

### Description of Related Art

Ladder tree stands, climbing tree stands, and tree climbing saddles are well known in the realm of hunting. Such tree stands allow a hunter to ascend a tree to a necessary height to hunt or observe covertly from an elevated position. However, during tree stand deployment and during use following deployment, the hunter will be accompanied by all the tools and necessary gear for their purposes including climbing aides, weapons, optical aids, backpacks, water bottles, and other related implements. Most tree stands do not come equipped with reasonable methods of stowing and accessing additional gear while the tree stand is being deployed or is in use.

In these situations, the hunter will typically install a hook with an attached lag screw into the truck of the tree being climbed in order to hang accessories or additional gear from. The hooks are installed at an appropriate height to allow the hunter to stow and access the gear comfortably. This requires drilling into the tree in some fashion which is time consuming, noisy, and can harm the tree immediately or throughout its life. Additionally, tree stands are often used on publicly accessible land such as wildlife production areas or state parks where it is not legal to drill into trees.

Another solution that is available for tree stand users to manage their gear are gear hangers such as the one depicted by U.S. Design Pat. D956533 S approved Jul. 5, 2022. This device is designed to be utilized with webbing straps and cannot be readily removed from the webbing to shift the device during use and thus doesn't allow easy adjustment or repositioning of the device for new applications. Another class of solutions is shown in U.S. Design Pat. D896064 S approved Sep. 15, 2020. This is a hook that is fixed to a strap which cannot be readily shifted either and cannot be readily adapted to additional uses and storage applications in the field. Finally, all three solutions cannot be utilized in conjunction with harnesses, webbing, or climbing rope that are already in use, necessitating the accompaniment of additional webbing and rope making these devices bulky and untidy. These drawbacks result in excess movement and noise which can give away a hunter's position to their intended quarry.

Another available solution is a typical S-hook which can be used over webbing or rope cordage already in use and can be used in conjunction with the users climbing harness to provide a stowage and access point for gear, but these tend to shift, slip off, or rotate in an undesirable way making them unsafe and unreliable. Typical S-hooks don't have deep enough hook loops to accommodate a variety of gear storage needs and provide easy access when desired, making them cumbersome in use. Also, readily available S-hooks are typically to thin and sharp, such that overtime they can wear and stress the webbing or rope leading to premature failure.

Hunters require lightweight, secure, and compact storage options for their gear that can transition through multiple configurations of use during tree stand deployment and use. It would be ideal if these solutions could also integrate with their webbing climbing harnesses or saddles to provide temporary storage and access while climbing. Advancements that address these issues and those listed above would be welcome advances in the art.

### BRIEF SUMMARY OF THE INVENTION

The above-described shortcomings are overcome through the provision of a BrowHook. In particular a BrowHook is a utility hook with a hook loop of sufficient depth and extension to accommodate common hunting gear, accessories, or tools, an attached clip with retention lip that can be used with webbing or rope to securely hold the hook to a structure, and having serrations or knurling applied to the face of the device that contacts the structure in order to provide additional stability against slippage or rotation relative to the webbing, rope, or surface.

The BrowHook can be utilized by installation over the many forms of webbing straps of various compositions and sizes or rope of varying diameter and construction that are present in outdoor/indoor life. The device can also be utilized over belts, harnesses, modular lightweight load-carrying equipment webbing, rigid bodies of sufficiently small cross section, and loops constructed of numerous materials.

The BrowHook provides a compact, non-invasive, stable, and reliable form of gear storage for hunters while retaining its ability to be deployed in a variety of configurations on existing webbing and cordage already in use while hunting without causing undo wear to equipment or excess movement and noise while being used or repositioned.

### BRIEF DESCRIPTION OF THE SEVERAL VIEWS OF THE DRAWING(S)

The foregoing and other features and advantages will be discussed in detail following non-limiting description of specific embodiments in connection with the accompanying drawings in which:

FIG. 1 is an orthogonal view of the BrowHook;

FIG. 2 is a side view of the BrowHook to give clarity to the profile of the device;

FIG. 3 is a side view reference diagram of the BrowHook indicating where detail views FIG. 3A, FIG. 3B, and FIG. 3C have been taken;

FIG. 3A is a detail of the side view depicting the radius of the inside upper face of the BrowHook securement clip slot;

FIG. 3B is a detail of the side view depicting the side profile of applied serrations to BrowHook face that will be held against a structure;

FIG. 3C is a detail of the side view depicting the retention lip at the gate of the securement clip slot.

### DETAILED DESCRIPTION OF THE INVENTION

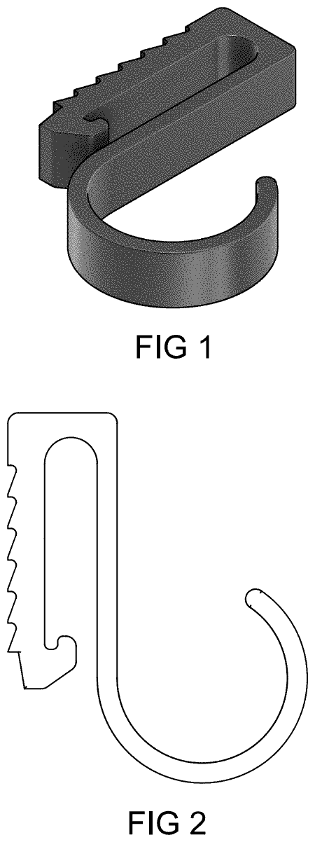

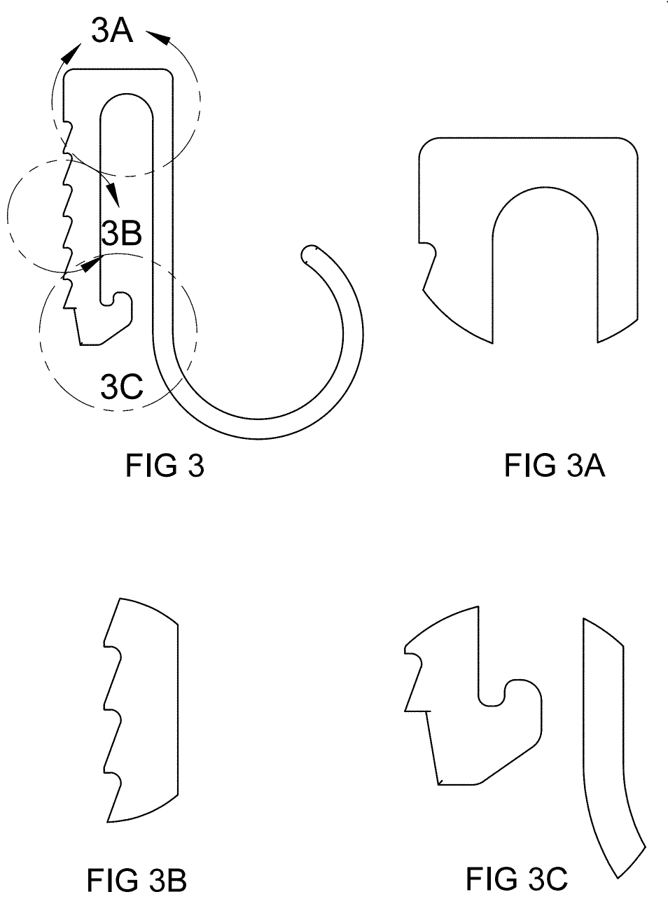

A BrowHook FIG. 1 is a solid bodied 3-dimensional device comprised of a relatively deep, extended hook having an attached securement clip with serrations or knurling FIG. 3B at its rear face, wherein the gate of the securement clip is partially obstructed by a retention lip FIG. 3C. The upper inside face of the securement clip slot FIG. 3A is radiused to ease stress on objects inserted therein when the device's securement clip is installed over them.

A BrowHook can be installed on any material that has a cross section of sufficiently small thickness or acceptable compressibility to slip between the retention lip FIG. 3C and the hook. For example, a piece of 2″ nylon webbing could be slipped into the securement clip gate or a piece of ½″ climbing rope could be squeezed through the securement clip gate. When being secured against a structure with a cinch belt, the belt should be cinched down in place to hold the BrowHooks serrated rear face FIG. 3B firmly against the surface. A load is applied to the hook at this point. Some examples of common loads would be rifles suspended by a sling, backpacks suspended by carry handles, or crossbows hung by their stirrup. As the load is applied, the weight pulls the cinch material downward, further tightening the cinch and pressing the serrations FIG. 3B into the surface. The engagement of the serrations prevents further slippage of the cinch belt and adds to further stability to the BrowHook to prevent the device from rotating relative to the structure or the cinch belt. When installed on a free floating structure such as a climbing harness, the retention clip is installed over the webbing or tie off handles. It can be placed anywhere that is necessary to provide access to or storage of gear.

The device is best manufactured using the injection molding process with a polymer material and metal mold. Polymers provide sufficient strength for most BrowHook applications while allowing for sufficient flexibility in the device to allow objects to be squeezed through the securement clip gate or firmly seating larger objects into the hook loop.

In order to deploy the device, it is held in the hand with the securement clip gate faced toward the object on which it is to be installed. The securement clip gate is passed over the object and forced onward until the object is seated as firmly as possible in the securement clip slot. The BrowHook can now be slid back and forth along the object to the extent possible and a load can be applied. When prepared to remove the BrowHook, with the load removed and the object firmly in place, lift the BrowHook off the object pulling 180 degrees away from the securement clip gate, flexing the gate open if necessary for removal.

1. A BrowHook, comprising: of a hook whose size is of sufficient depth and extension to accommodate the suspension of common gear, an attached securement clip with retention lip that can be used with webbing or rope to securely hold the device to a structure or allow attachment to a free floating structure, and having serrations or knurling applied to the face of the device intended to contact a structure in order to provide additional stability against slippage or rotation relative to the webbing, rope, or surface.
